(19) United States
(12) Patent Application Publication
(10) Pub. No.: US 2025/0368182 A1
(43) Pub. Date: Dec. 4, 2025

(54) ACTUATING WHEELS OF TOWED VEHICLE TO MITIGATE FOR INSTABILITY

(71) Applicant: TOYOTA RESEARCH INSTITUTE, INC., LOS ALTOS, CA (US)

(72) Inventors: ANDREA MICHELLE RIOS LAZCANO, Brussels (BE); HIROSHI YASUDA, San Francisco, CA (US)

(73) Assignees: TOYOTA RESEARCH INSTITUTE, INC., LOS ALTOS, CA (US); TOYOTA JIDOSHA KABUSHIKI KAISHA, TOYOTA-SHI (JP)

(21) Appl. No.: 18/680,671

(22) Filed: May 31, 2024

(51) Int. Cl. B60W 30/02; B60W 10/04; B60W 10/20; B60W 60/00

(52) U.S. Cl. CPC B60W 30/02; B60W 10/04; B60W 10/20; B60W 60/001; B60W 2710/207; B60W 2720/28

(57) ABSTRACT

Systems and methods are provided for improved stability of a towed vehicle by mitigating disturbances due to external conditions that may negatively impact the stability. Examples mitigate these disturbances by controlling vehicle systems of the towed vehicle based on recognizing an onset of a disturbance. For examples, the systems and methods can control one or more wheels of the towed vehicle in a manner selected to counteract the disturbances, thereby mitigating negative impact resulting therefrom.

### TECHNICAL FIELD

The present disclosure relates generally to systems and methods for mitigating instability in a vehicle being towed, and, more particularly, some embodiments relate to actuating wheels of a vehicle being towed to mitigate instability.

### DESCRIPTION OF RELATED ART

Towing a vehicle, such as by a tow truck or other vehicle, presents unique operating considerations for a driver of the tow truck that are generally not present when operating a vehicle without a towed vehicle. For example, towing a vehicle can change operating characteristics of the tow truck such as stopping distance, maneuverability, and so on. Additionally, environmental characteristics such as crosswind, pressure fronts from other vehicles, and other such occurrences can have a negative effect on stability of the vehicle-tow truck pair. Other environmental characteristics may include load transfers due to contents of the towed vehicle shifting during the travel, abrupt driver behavior when driving the towing vehicle, uneven road surfaces (e.g. road slopes due to road camber or road downhill profiles), etc. In other words, because of dynamics that exist between the towed vehicle and the tow truck due to, for example, an attachment mechanism, such as a tow hitch (also referred to as a tow bar or trailer hitch), between the towed vehicle and the tow truck, an extension in overall length/wheelbase, and other such considerations, the towed vehicle-tow truck pair can experience various effects, such as sway, jackknifing, or the like, that are not generally present otherwise.

Consequently, towing-related accidents can result when a driver is inexperienced with controlling the towed vehicle-tow truck pair to mitigate such issues or is otherwise incapable of preventing the instability due to poor reaction time, a severity of forces inducing the instability, and so on. As such, operating a vehicle that is towing another vehicle trailer presents unique safety considerations in relation to ensuring the stability of the towed vehicle under various operating conditions.

### BRIEF SUMMARY OF THE DISCLOSURE

According to various embodiments of the disclosed technology, systems and methods for actuating wheels of a vehicle being towed to mitigate instability.

In accordance with some embodiments, a method is provided. The method comprises analyzing sensor data from at least one sensor positioned within an environment in which a first vehicle is traveling to generate a stability signature that characterizes external conditions experienced by the first vehicle while the first vehicle is towed by a second vehicle; and in response to determining the stability signature satisfies a stability threshold indicating an onset of an instability of the first vehicle, generating a control signal based on the stability signature that actuates a wheel of the first vehicle to mitigate the instability of the first vehicle.

In another aspect, a vehicle stabilization system is provided that comprises a first vehicle having a wheel and a vehicle system configured to control the wheel, a memory storing instructions, and one or more processors communicably coupled to the memory. The one or more processors are configured to execute the instructions analyze sensor data from at least one sensor positioned within an environment in which the first vehicle is traveling to generate a stability signature that characterizes external conditions experienced by the first vehicle while the first vehicle is towed by a second vehicle. Additionally, the one or more processors are configured to, in response to determining the stability signature satisfies a stability threshold indicating an onset of an instability of the first vehicle, generate a control signal based on the stability signature, and provide the control signal to the vehicle system to actuate the wheel of to mitigate the instability of the first vehicle.

In another aspect, a vehicle is provided. The vehicle comprises a wheel that is lifted off a road surface while the vehicle is towed, a vehicle system configured to control the wheel, and a stabilization system. The stabilization system is configured to receive a control signal in response to a determination that a stability signature satisfies a stability threshold indicating an onset of an instability of the vehicle, and operate the vehicle system to autonomously control the wheel according to the control signal to mitigate the instability of the vehicle. The stability signature is based on sensor data from at least one sensor positioned within an environment in which the vehicle is traveling and characterizes external conditions experienced by the vehicle while the vehicle is towed.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for mitigating instability in a towed vehicle in accordance with one embodiment of the systems and methods described herein.

FIG. 4 illustrates an example environment in which embodiments of the systems and methods disclosed herein may be implemented.

FIG. 5 is a flow chart illustrating example operations for mitigating instability of a towed vehicle in accordance with various embodiments disclosed herein.

FIG. 6 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provide for improved stability of a vehicle (referred to herein as “towed vehicle”) that is being towed by another vehicle (referred to herein as “towing vehicle”) by mitigating disturbances due to external conditions that may negatively impact the stability of the towed vehicle. As previously noted, instability in a towed vehicle may result in adverse occurrences, such as accidents. That is, because the towed vehicle can become difficult to control when experiencing instability conditions, such as sway, jackknifing or the like, and such occurrences may cause the towed vehicle to tip, inadvertently cross lane boundaries, or to collide with other vehicles/obstacles. Embodiments disclosed herein mitigate these instability conditions by controlling vehicle systems of the towed vehicle based on recognizing an onset of an instability condition. In an illustrative example, embodiments disclosed herein can control one or more wheels of the towed vehicle in a manner selected to counteract disturbances that may cause instability of the towed vehicle, thereby mitigating negative impact resulting from such conditions.

Sway in a towed vehicle can occur when lateral forces on the towed vehicle induce oscillating motion along a path of the towed vehicle with respect to the towing vehicle. The lateral forces (e.g., perpendicular to a direction of travel) can result from differences in pressure on opposing sides of the towed vehicle, which may be induced by conditions external to the towed vehicle/towing vehicle pair. External conditions, as used herein, may refer to conditions or characteristics of an environment surrounding the towed vehicle/towing vehicle pair and external thereto, for example, but not limited to, crosswinds, pressure fronts of passing vehicles (e.g., passing semi-trucks), and so on. For example, a crosswind may generate force having a lateral force component and a longitudinal force component (e.g., parallel to the direction of travel). The lateral force component may impact the side of the towed vehicle. Because this is an unopposed force (i.e., there is no balancing force on the opposite side of the towed vehicle) a net resulting lateral force pushes against the towed vehicle in a generally perpendicular direction to that of the direction of travel.

In general, lateral forces that exceed a steady state threshold force may push a rear of the towed vehicle in one direction, which induces the front of the towed vehicle to move in an opposing direction and a bend in a hitch point between the towed and towing vehicle in the opposing direction. Thus, as the towed vehicle moves along the direction of travel, a swaying motion of the towed vehicle evolves into back and forth oscillations of the towed vehicle that opposes a desired path (e.g., straight-line, curved-line through a curved road, etc.) of the towing vehicle along the direction of travel. The steady state threshold force may represent a maximum lateral force at which the towed vehicle/towing vehicle pair remains in steady state. This steady state threshold force may be computed from a moment of inertia of the towed vehicle/towing vehicle pair (e.g., based on a velocity and a mass of the pair of vehicles). The point where the lateral forces exceed the steady state threshold force may be represent an onset of an instability condition of the vehicle pair. At this juncture, the lateral forces may exert forces on the towing vehicle/towed vehicle pair affecting overall motion and control. Moreover, because manually detecting and preventing occurrences of sway can be difficult for a driver, and, especially for a driver that lacks experience, the driver may not detect the sway in time to provide manual controls that counteract the sway and/or may not provide appropriate controls. As such, the towing vehicle and the towed vehicle may experience sway conditions that result in an uncontrollable state and thus adverse outcomes, such as jackknifing.

Accordingly, examples disclosed herein provide a stabilization system that improves stability of a towed vehicle by detecting an occurrence of instability in a towed vehicle (e.g., sway and the like) and autonomously operating the towed vehicle to mitigate the instability before it evolves into an uncontrollable event. Embodiments disclosed herein can employ sensors (e.g., pressure sensors, cameras, weather sensors, and other vehicle sensors) to obtain information that can be used to generate a stability signature that characterizes external conditions of an environment in which the towed vehicle is traveling. Embodiments disclosed herein may then use the stability signature to detect instability conditions that could lead to instability in the towed vehicle. That is, for example, embodiments disclosed herein characterize external conditions experienced by the towed vehicle by monitoring sensor data for aspects that are indicative of the onset of instability (e.g., bend in the hitch point, sway or the like). The sensor data may comprise vehicle dynamic data representative of motion characteristics of the towed vehicle, towing vehicle, or the pair and/or environmental data representative of the surrounding environment in which the pair of vehicles travel. The sensor data can be analyzed to generate the stability signature as a characterization of external conditions that impact stability of the towed vehicle. The stability signature can be compared to a stability threshold to determine if the stability signature is indicative of the onset of instability condition. Responsive to satisfying the stability threshold, embodiments herein may generate one or more control signals that operate one or more vehicle systems of the towed vehicle in a manner to counteract or otherwise mitigate the instability condition of the towed vehicle. In illustrative examples, the control signals may actuate one or more of the wheels of the towed vehicles to counteract or otherwise mitigate the instability condition.

In an example, the stabilization system disclosed herein monitors sensor data, obtained from any number of sources, to characterize external conditions experienced by the towed vehicle. The towed vehicle can be hitched to the towing vehicle in a manner that causes one or more axels of the towed vehicle to be lifted off the ground (or road surface), which ultimately causes one or more wheels corresponding to the one or more axels to be lifted off the ground. In various examples, the lifted axel may be a front-axel and the one or more lifted wheels may be the front wheels. The stabilization signature generated by embodiment disclosed herein may include information indicating a state of one or wheels being lifted off of the ground, which indicates that the vehicle is being towed and is subject to stability concerns.

The stabilization system may monitor the sensor data to detect vehicle and/or environmental conditions that are indicative of unopposed lateral forces applied to the towed vehicle. In some examples, stabilization system may use environmental sensors (e.g., wind and/or weather sensors) to detect external conditions in an environment in which the towed vehicle travels (such as crosswinds in various examples). In some examples, the stabilization system may communicate using vehicle-to-infrastructure (V2I) communications to obtain current weather conditions or weather forecasts to monitor crosswinds conditions detected by environmental sensors external to the towed vehicle. In some examples, the towed vehicle may communication with the towing vehicle using vehicle-to-vehicle communications to obtain sensor data. In these examples, sensor data may include environment data, such crosswind conditions (e.g., wind direction and wind speed). The stabilization system may determine an unopposed lateral force applied to the towed vehicle from the wind direction and wind speed. This information can be included in a stabilization signature generated based on the environment data, which characterizes the crosswind condition. Accordingly, the stability signature may comprise a measure (or estimate) of the lateral force due to the detected wind speed and wind direction.

The stability signature can be compared to the stability threshold to determine whether or not the stability signature is indicative of the onset of an instability condition. For example, the stability signature may be indicative of an instability condition if the lateral force set forth in the stability signature is equal to or exceeds the stability threshold, provided as a steady state threshold force in this example.

In another example, stabilization system may monitor vehicle dynamics of the towed vehicle/towing vehicle pair based on sensor data. The stabilization system may obtain sensor data from one or more of the towed vehicle and towing vehicle and derive current real-world vehicle dynamics from the sensor data. The current vehicle dynamics can be compared to expected vehicle dynamics to determine a difference therebetween. This difference can characterize external conditions experienced by the towed vehicle that has induced the deviation from the expected dynamics. A lateral force applied to the towed vehicle that caused the difference can be computed from the difference and used to generate a stabilization signature. For example, wheel dynamics, such as an orientation of the one or more lifted wheels relative to a direction of travel may be monitored, for example, by wheel angle sensors and/or wheel torque sensors. The detected orientation can be compared to an expected orientation to determine an offset (e.g., a difference). This offset may be indicative of an external condition (e.g., cross wind applied to the one or more lifted wheels causing deviation from the expected direction), which can be translated into a lateral force and used for a stability signature. In another example, vehicle dynamics of the towed vehicle can be obtained from sensor data and used to determine a current lateral position of the towed vehicle relative to the towing vehicle and the direction of travel. The lateral position can be compared to an expected lateral position to determine an offset therebetween. As in the preceding example, the offset may be indicative of an external condition (e.g., cross wind applied to the vehicle causing deviation from the expected lateral position), which can be translated into a lateral force and used to generate the stability signature. In either case, the stability signature can be compared to the stability threshold and used to recognize an onset of an instability condition if it is equal to or exceeds the stability threshold.

In any case, the stabilization system may generate a control signal that can cause actuation of the one or more lifted wheels in a way to counteract the instability condition when the stability signature is equal to or exceeds the stability threshold. In an illustrative example, the control signal may cause a steering angle of the one or more lifted wheels to be adjusted in a direction selected to mitigate the instability condition. For example, the stabilization system may detect an unopposed lateral force, as described above, and adjust the steering angle of one or more of the lifted wheels based on the lateral force. For example, if the stabilization system determines there is strong lateral force (e.g., due to a crosswind or otherwise) incident on the driver side front of the towed vehicle, the stabilization system may steer one or more lifted wheels toward the lateral force (e.g., in a direction toward parallel with the crosswind) to minimize the impact of the lateral force (e.g., to minimize a lateral force due to the cross wind) and increase aerodynamics. As another example, the stabilization system may determine to increase an unopposed lateral force applied to the one or more lifted wheels, and ultimately to the towed vehicle, by steering the one or more lifted wheels away the lateral force to counteract an already occurring instability condition, such as jackknifing. Accordingly, the direction that the one or more lifted wheels are steered may depend on whether the stabilization system is attempting to minimize lateral force and/or maximize lateral force (e.g., prevent jackknifing). In any case, the stabilization system can be configured to steer the one or more lifted wheels in a manner to prioritize safety of the towed vehicle by minimizing instability conditions caused by external conditions.

The determination on whether to minimize or maximize the lateral force may be based on comparing the direction of the unopposed lateral force with a direction of bending in a hitch point between the towed and towing vehicle. For example, during an instability condition, a hitch point may bend due to the rear of the towed vehicle being pushed in one lateral direction and the front of the towed vehicle moving in the opposing direction. As a result, the hitch point bends in the opposing direction, in this example. The bend direction may be an example of a vehicle dynamic. The stabilization system may be configured to compare the bending direction of the hitch point to the direction of the unopposed lateral force. If the bending direction is in the same direction as the unopposed lateral force, the stabilization system may be configured to maximize the impact of the lateral force by steering one or more wheels in a direction away the unopposed lateral force. Whereas, if the bending direction is in the opposite direction as the unopposed lateral force, the stabilization system may be configured to minimize the impact of the lateral force by steering one or more wheels in a direction toward the unopposed lateral force.

In an illustrative example, jack-knife instability may become unrecoverable (e.g., exceeds a stability threshold) when the hitch articulation point (e.g., bending point) reaches a critical angle. While the critical angle may be dependent on multiple factors, such as but not limited to, the mass of towing vehicle, the mass of the towed vehicle, weight distribution, tire properties, road conditions, etc., in some examples critical angle may be between 45 to 60 degrees. Thus, the stabilization system may detect a bending angle using sensors (e.g., a hitch sensor) to compare this bending angle to a critical angle, computed in advance, as an example stability threshold. Based on detecting the current angle exceeds the critical angle, the stabilization system may recognize the conditions as an onset of an instability condition (e.g., jack-knife instability) and actuate the wheels, in accordance with examples herein, to minimize the instability condition.

In another illustrative example, an onset of a sway instability condition may also be recognized (e.g., detected) based on a bending angle of the hitch. For example, sway instability may occur when the bending angle of the hitch is exceeds plus/minus 20 degrees. In some examples, sway instability of a towing vehicle/towed vehicle pair can be defined when the bending angle oscillates with values above 4 degrees. Increasing the value of this angle above this threshold increases criticality and means it may be more difficult to recover stable-state conditions. Other metrics to determine sway can be based on ratio of the yaw rate or lateral acceleration of the towing vehicle to the yaw rate or lateral acceleration of the towed vehicle, respectively.

In another example, the stabilization system may generate a control signal that causes the one or more lifted wheels to rotate at an angular velocity during towing, thereby creating a gyroscopic effect. As a result of the gyroscopic effect, the one or more lifted wheels can mitigate movement of the one or more lifted wheels, as well as the lifted portion of the towed vehicle, from oscillating relative to the towing vehicle due to lateral forces induced by external conditions. That is, the orientation of the one or more lifted wheels can be maintained at in a stable state and unaffected by lateral forces that result from external conditions, which could otherwise cause instability conditions, by the induced gyroscopic effect. The angular velocity at which the one or more lifted wheels are rotated can be based on an angular momentum needed to induce the gyroscopic effect, which may be based on a radius of the one or more lifted wheels and a mass thereof.

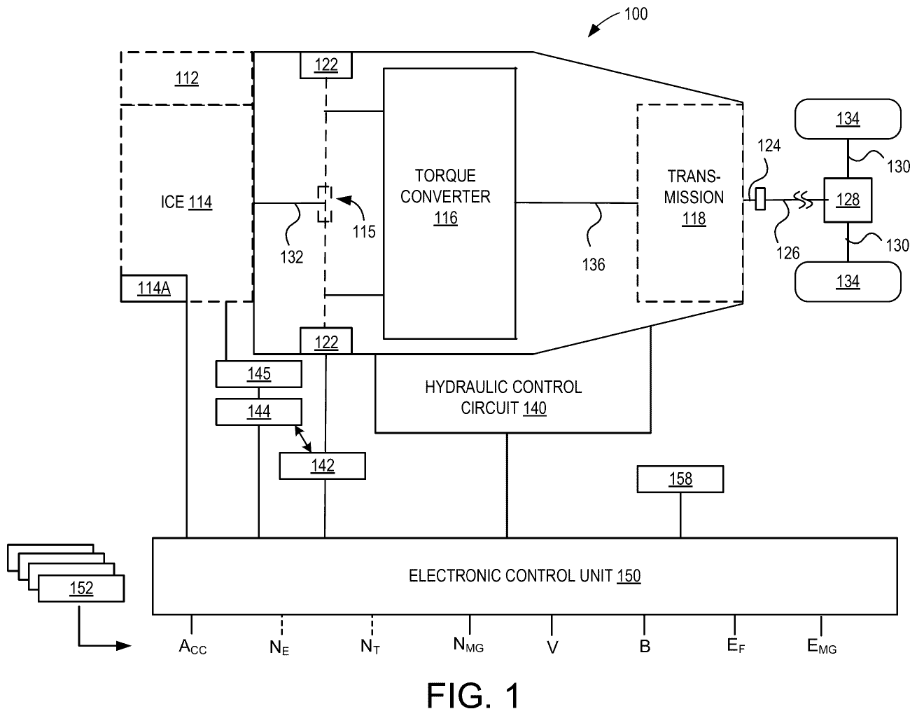

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for mitigating instability of a towed vehicle can be implemented in other types of vehicle including gasoline- or diesel-powered vehicles, fuel-cell vehicles, electric vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount (A_{CC}), a revolution speed (N_{E}) of internal combustion engine 114 (engine RPM), a rotational speed (N_{MG}) of the motor 122 (motor rotational speed), and vehicle speed (N_{V}). These may also include torque converter 116 output (N_{T}) (e.g., output amps indicative of motor output), brake operation amount/pressure (B), and battery SOC (i.e., the charged amount for battery 144 detected by an SOC sensor). Furthermore, in some examples, the electronic control unit 150 may receive signals that indicate environmental conditions or characteristics, or signals that can be used to derive vehicle operating conditions or characteristics. These may include, but are not limited to, weather conditions surrounding vehicle 100 (e.g., wind speeds and wind directions), pressure fronts from passing vehicles, and other lateral forces applied to the vehicle 100. Accordingly, vehicle 100 can include a plurality of sensors 152 that can be used to detect various conditions internal or external to the vehicle and provide sensed conditions to engine control unit 150 (which, again, may be implemented as one or a plurality of individual control circuits). Furthermore, sensors may be included that measure yaw rate, lateral acceleration, hitch angle, driver behavior (e.g., steering angle or steering torque), and road conditions (e.g., slope, incline, curvature, etc.).

In some embodiments, one or more of the sensors 152 may include their own processing capability to compute the results for additional information that can be provided to electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, weather sensors (such as, but not limited to, wind sensors). Sensors 152 may also include sonar, radar, lidar or other vehicle proximity sensors, and cameras or other image sensors. Image sensors can be used to detect objects in an environment surrounding vehicle 100, for example, passing vehicles. While some sensors can be used to actively detect passive environmental objects, other sensors can be included and used to detect active objects such as those objects used to implement smart roadways that may actively transmit and/or receive data or other information.

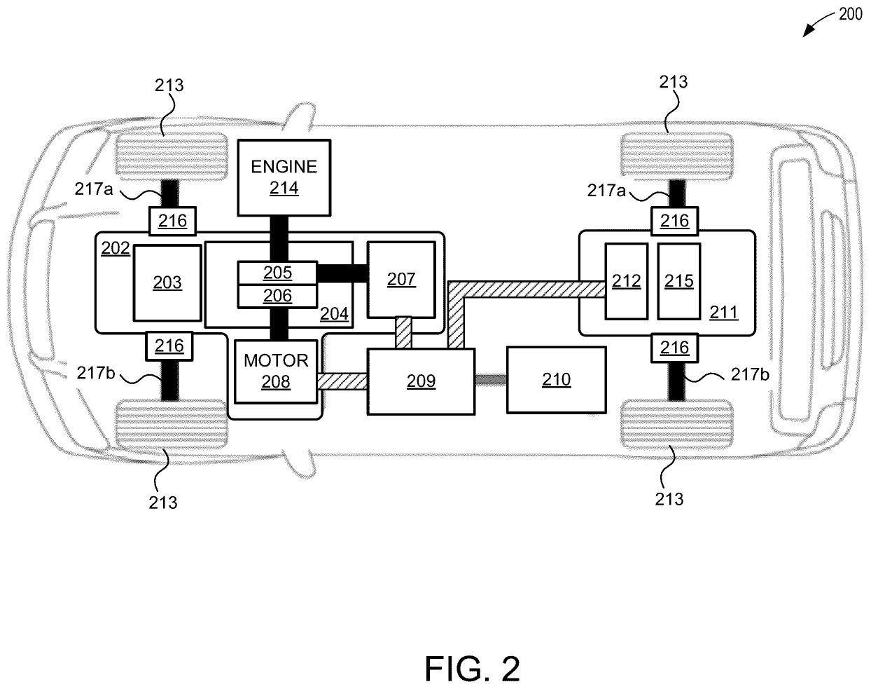

FIG. 2 is another example of a vehicle with which systems and methods for mitigating instability of a towed vehicle may be implemented. The example illustrated in FIG. 2 is illustrates a hybrid vehicle drive system of a vehicle 200, which may be an example implementation of vehicle 100. That is, vehicle 200 may include all the components described above in connection with vehicle 100, plus the additional components described herein.

Vehicle 200 may include an engine 214 (e.g., engine 114) and one or more electric motors 208, 212 (e.g., motors 122) as sources of motive power. Driving force generated by the engine 214 and motors 208, 212 can be transmitted to one or more wheels 134 via hybrid transaxle assemblies 202, 211 and pairs of axles 230a, 230b, 232a, 232b. That is, for example, driving force can be transmitted from engine 214 and/or motor 208 to one or more front wheels 134 via hybrid transaxle assembly 202 and axle 230, and driving force can be transmitted from engine 214 and/or motor 212 to one or more rear wheels 134 via hybrid transaxle assembly 211 and axle 232. As such, drive motors 208 and 212 may be considered front and rear drive motors, respectively.

In this example, hybrid transaxle assembly 202 includes front differential 203, a compound gear unit 204, a motor 208, and a generator 207. Compound gear unit 204 includes a power split planetary gear unit 205 and a motor speed reduction planetary gear unit 206. Hybrid transaxle assembly 202 enables power from engine 214, motor 208, or both, as described above in connection with FIG. 1, to be applied to axle 130 and ultimately front wheels 213 via front differential 203.

In this example, hybrid transaxle assembly 211 includes rear differential 215 and motor 212. Hybrid transaxle assembly 202 enables power from engine 214, motor 212, or both, as described above in connection with FIG. 1, to be applied to axle 230 and ultimately to rear wheels 213 via rear differential 215.

This example vehicle 200 also includes an inverter with converter assembly 109 and battery 110 (which may include multiple batteries). The inverter with converter assembly 209 inverts DC power from battery 210 to create AC power to drive AC motors 208, 212. In embodiments where motors 208, 212 are DC motors, no inverter is required. Inverter with converter assembly 209 also accepts power from generator 207 (e.g., during engine charging) and uses this power to charge battery 210.

In certain examples, vehicle 200 may be an example of an over-actuated vehicle. As used herein, an “over-actuated vehicle” refers to a vehicle having more actuators than degrees of freedom. For example, generally a vehicle has two degrees of freedom and two actuators (i.e., one actuator for rolling the vehicle's tires and another actuator for steering the vehicle's tires). Whereas, an over-actuated vehicle may have more than two actuators. Accordingly, an over-actuated vehicle can be more flexibility in movement than conventional vehicles. For example, an over-actuated vehicle can have independent steering capabilities corresponding to each wheel, such that each wheel can be independently actuated and controlled. Examples of the steering capabilities include, but are not limited to, zero turn (e.g., a turning radius that is effectively zero due to drive wheels rotating in opposing directions); diagonal driving; carb driving; and pivot turning.

In an example of FIG. 2, vehicle 200 may comprise a plurality of actuators 216, each corresponding to a wheel 213. Each actuator 216 can be independently controlled to steer a corresponding wheel 213 independent from the other wheels 213. In some examples, actuators 216 may be in-wheel motors, such as motors 208 and/or 212, that can control brake and torque for each corresponding wheel. Actuators 216 can be controlled to provide the steering capabilities described above by switching between front, rear, and all-wheel drive and torque vectoring, which can include adjusting the torque of each individual wheel 213 independent of other wheels 213, which provide more precise vehicle control. In some examples, vehicle 200 may control the actuators 216 via steer-by-wire systems.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

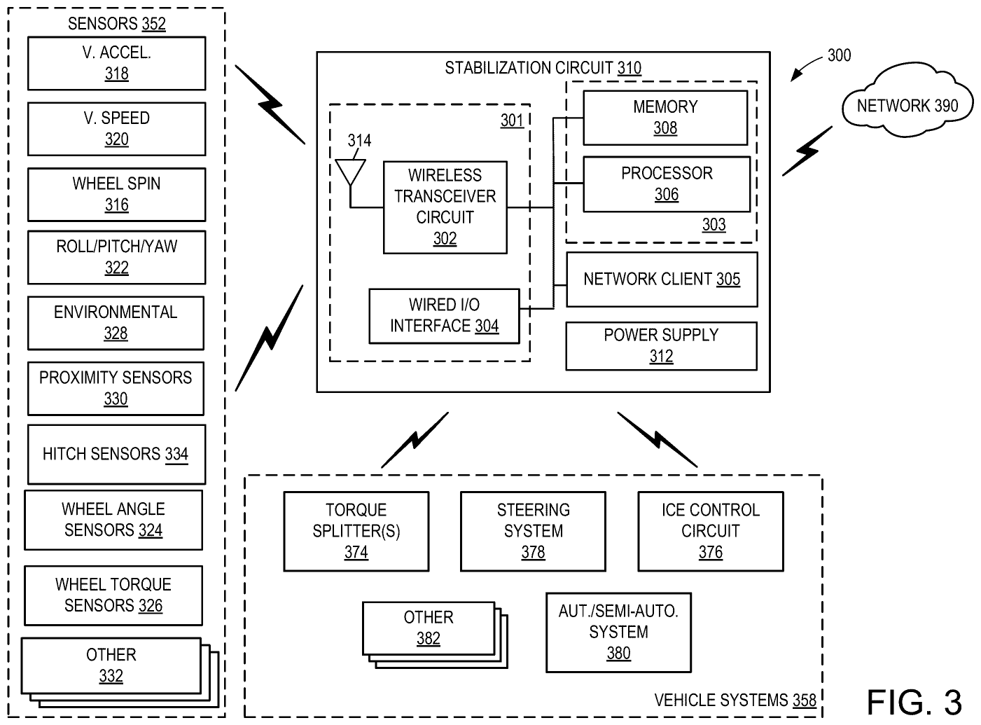

FIG. 3 illustrates an example architecture for mitigating instability in a towed vehicle in accordance with one embodiment of the systems and methods described herein. Referring now to FIG. 3, in this example, stabilization system 300 includes a stabilization circuit 310, a plurality of sensors 352 and a plurality of vehicle systems 358. Sensors 352 (such as sensors 152 described in connection with FIG. 1) and vehicle systems 358 (such as subsystems 158 described in connection with FIG. 1) can communicate with stabilization circuit 310 via a wired or wireless communication interface. Although sensors 352 and vehicle systems 358 are depicted as communicating with stabilization circuit 310, they can also communicate with each other as well as with other vehicle systems. stabilization circuit 310 can be implemented as an ECU or as part of an ECU such as, for example electronic control unit 150. In other embodiments, stabilization circuit 310 can be implemented independently of the ECU.

Stabilization circuit 310 in this example includes a communication circuit 301, a decision circuit 303 (including a processor 306 and memory 308 in this example) and a power supply 312. Components of stabilization circuit 310 are illustrated as communicating with each other via a data bus, although other communication in interfaces can be included. Stabilization circuit 310 in this example also includes network client 305 that can be operated to connect to an edge or cloud-based server of a network 390 to obtain sensor data from external infrastructure. For example, stabilization circuit 310 may download a weather forecasts or weather data of current real-world weather conditions via communication circuit 301.

Processor 306 can include one or more GPUs, CPUs, microprocessors, or any other suitable processing system. Processor 306 may include a single core or multicore processors. The memory 308 may include one or more various forms of memory or data storage (e.g., flash, RAM, etc.) that may be used to store instructions and variables for processor 306 as well as any other suitable information, such as, one or more of the following elements: external condition data (e.g., information indicative of external conditions of an environment in which the vehicle is traveling), sensor data, and stability thresholds, along with other data as needed. Memory 308 can be made up of one or more modules of one or more different types of memory, and may be configured to store data and other information as well as operational instructions that may be used by the processor 306 to stabilization circuit 310.

Although the example of FIG. 3 is illustrated using processor and memory circuitry, as described below with reference to circuits disclosed herein, decision circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a stabilization circuit 310.

Communication circuit 301 includes either or both a wireless transceiver circuit 302 with an associated antenna 314 and a wired I/O interface 304 with an associated hardwired data port (not illustrated). Communication circuit 301 can provide for vehicle-to-everything (V2X) and/or vehicle-to-vehicle (V2V) communications capabilities, allowing stabilization circuit 310 to communicate with edge devices, such as roadside unit/equipment (RSU/RSE), network cloud servers and cloud-based databases, and/or other vehicles via network 390. For example, V2X communication capabilities allows stabilization circuit 310 to communicate with edge/cloud servers, roadside infrastructure (e.g., such as roadside equipment/roadside unit, which may be a vehicle-to-infrastructure (V2I)-enabled street light or cameras, for example), etc. stabilization circuit 310 may also communicate with other connected vehicles over vehicle-to-vehicle (V2V) communications.

As this example illustrates, communications with stabilization circuit 310 can include either or both wired and wireless communications circuits 301. Wireless transceiver circuit 302 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by stabilization circuit 310 to/from other entities such as sensors 352 and vehicle systems 358.

Wired I/O interface 304 can include a transmitter and a receiver (not shown) for hardwired communications with other devices. For example, wired I/O interface 304 can provide a hardwired interface to other components, including sensors 352 and vehicle systems 358. Wired I/O interface 304 can communicate with other devices using Ethernet or any of a number of other wired communication protocols whether standardized, proprietary, open, point-to-point, networked or otherwise.

Power supply 312 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 352 can include, for example, sensors 152 such as those described above with reference to the example of FIG. 1. Sensors 352 can include additional sensors that may or may not otherwise be included on a standard vehicle with which the stabilization system 300 is implemented. In the illustrated example, sensors 352 include vehicle acceleration sensors 318, vehicle speed sensors 320, wheelspin sensors 316 (e.g., one for each wheel), accelerometers such as a 3-axis accelerometer 322 to detect roll, pitch and yaw of the vehicle, environmental sensors 328 (e.g., to detect salinity or other environmental conditions), and proximity sensor 330 (e.g., sonar, radar, lidar or other vehicle proximity sensors). Accelerometers 322 may be used to measure yaw rate and lateral acceleration. Environmental sensors 328 may include wind sensors that detect speeds and directions of crosswinds, as well as pressure sensors that may detect pressure fronts applied to the vehicle. Sensors 352 may also include wheel speed sensors 324 (e.g., one for each wheel) that detect a steering angle of each wheel, wheel torque sensors 326 (e.g., one for each wheel) that detect torque, speed, and temperature of each wheel, and hitch angle sensors 334 that detect a bend or angle of a hitch and a lateral direction of the detected bend or angle. Additional sensors 332 can also be included as may be appropriate for a given implementation of stabilization system 300. For example, sensors may be included for detecting steering angle, steering torque, and other driving behaviors.

The other sensors 332 may include one or more image sensors. These may include front facing image sensors, side facing image sensors, and/or rear facing image sensors. Image sensors may capture information which may be used in detecting not only vehicle conditions but also detecting conditions external to the vehicle as well. Image sensors can be used to, for example, to detect objects in an environment surrounding a vehicle comprising stabilization system 300, for example, passing vehicles, roadway environment, road lanes, road slope/incline, road curvature, obstacles, and so on.

Vehicle systems 358, for example, systems and subsystems 158 described above with reference to the example of FIG. 1, can include any of a number of different vehicle components or subsystems used to control or monitor various aspects of the vehicle and its performance. In this example, the vehicle systems 358 includes an engine control circuits 376 to control the operation of engine (e.g. internal combustion engine 114, engine 214, motors 122, and/or motors 208, 212); torque splitters 374 that can control distribution of power among the wheels such as, for example, by controlling front/rear and left/right torque split; steering system 278 (which may be the steering by-wire system described in conjunction with FIG. 2) to turn each wheel of the vehicle; autonomous or semi-autonomous driving systems 380; and other vehicle systems 382 (e.g., vehicle positioning system (e.g., GPS); object detection system; Advanced Driver-Assistance Systems (ADAS), such as forward/rear collision detection and warning systems, pedestrian detection systems, autonomous or semi-autonomous driving systems, and the like).

Torque splitters 374 and steering system 378 may be operatively connected to actuators for controlling wheels of the vehicle. For example, torque splitters 374 can be used to operate actuators (e.g., actuators 216) to control distribution of power among each wheels independent of other wheels. Thus, in the example of an over-actuated vehicle, each wheel can be actuated by torque splitters 374 to independently rotate each wheel at a desired angular velocity. Similarly, steering system 278 may be used to operate actuators (e.g., actuators 216) to turn the wheels of the vehicle. Thus, in the example of an over-actuated vehicle, each wheel can be actuated by tor steering system 278 to independently steer each wheel to a desired direction.

Autonomous or semi-autonomous driving systems 380 can be operatively connected to the various vehicle systems 358 and/or individual components thereof. For example, autonomous or semi-autonomous driving systems 380 can send and/or receive information from the various vehicle systems 358 to control the movement, speed, maneuvering, heading, direction, etc. of the vehicle. The autonomous or semi-autonomous driving systems 380 may control some or all of these vehicle systems 358 and, thus, may be semi- or fully autonomous. For example, autonomous or semi-autonomous driving systems 380 may semi- or fully autonomously control one or more of torque splitters 374 and steering system 378 to control distribution of power among the wheels and control the steering angle of each wheel.

Network 390 may be a conventional type of network, wired or wireless, and may have numerous different configurations including a star configuration, token ring configuration, or other configurations. Furthermore, the network 390 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 390 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 390 may include one or more IEEE 802.11 wireless networks.

In some embodiments, the network 390 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VoLTE); etc. In some examples, the V2X communications can include V2V communications, Vehicle-to-Infrastructure (V2I) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V2I) message, an LTE-V2N message, etc.); a 5G-V2X message; and a millimeter wave message, etc.

During operation, communication circuit 301 can be used to transmit and receive information between stabilization circuit 310 and sensors 352, and stabilization circuit 310 and vehicle systems 358. Also, sensors 352 may communicate with vehicle systems 358 directly or indirectly (e.g., via communication circuit 301 or otherwise). For example, communication circuit 301 may receive data from sensors 352 and/or systems 358, which can be provided to decision circuit 303. Decision circuit 303 can analyze the sensor data from sensors 352 to generate a stability signature that characterizes external conditions experienced by the vehicle. Based on the stability signature, decision circuit 303 may detect an onset of an instability condition and generate a control signal that can be provided to one or more systems 358 via communication circuit 301. The systems 358 can execute the control signals to actuate one or more wheels of the vehicle to mitigate an instability. In an illustrative example, the control signal may be provided to autonomous or semi-autonomous driving systems 380, which operates the torque splitters 374 and/or steering system 378 to actuate one or more wheels in a manner selected to mitigate the instability condition.

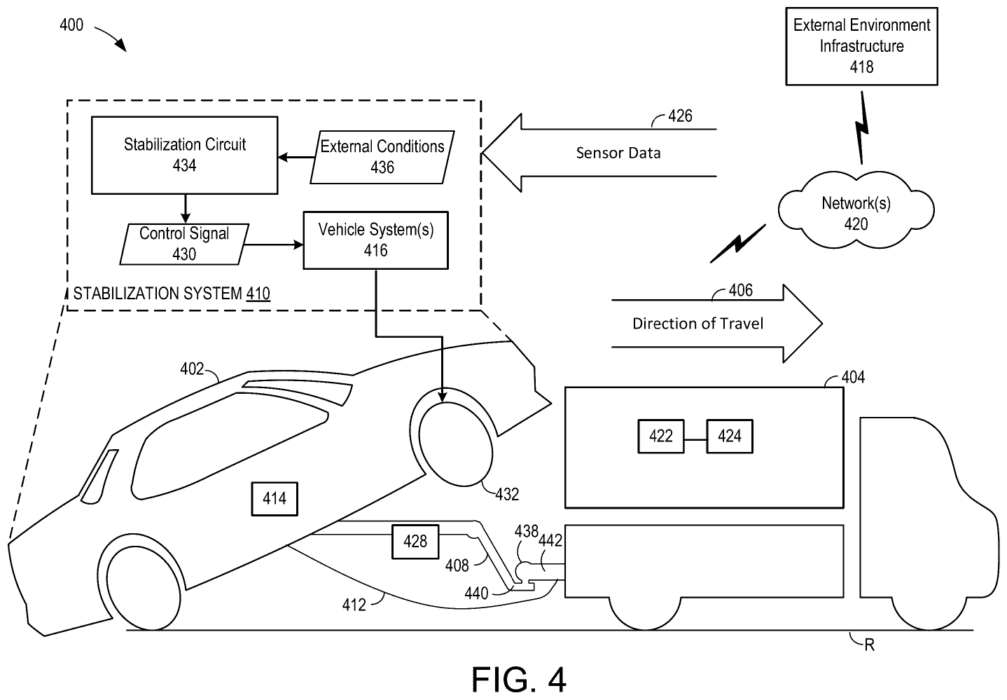

FIG. 4 is a schematic illustration of an vehicle stabilization system 400 for mitigating instability of a towed vehicle 402, in accordance with an illustrative embodiment of the disclosed technology. FIG. 4 depicts vehicle stabilization system 400 comprising a towed vehicle 402 attached to a towing vehicle 404 by way of a hitch 408 in a manner that causes the wheels 432 of towed vehicle 402 to be lifted off of a road surface R. The towed vehicle 402 may be communicatively coupled to towing vehicle 404 via a wiring harness 412. Towing vehicle 404 may be towing the towed vehicle 402 along a direction of travel 406. In the example of FIG. 4, wheels 432 are shown as the front wheels, but examples herein are not intended to be limited thereto. In another example, towed vehicle 402 may be towed in a manner that lifts rear wheels off the road surface R.

Towed vehicle 402 may be implemented as vehicle 100 of FIG. 1 and/or 200 of FIG. 2. Towed vehicle 402 may include a stabilization system 410, which may be substantially similar to stabilization system 300 of FIG. 3. The stabilization system 410 may be communicably coupled to sensors 414 (e.g., sensors 352 of FIG. 3) installed on the towed vehicle 402 and vehicle systems 416 (e.g., vehicle systems 358) of the towed vehicle 402 via a communication circuit (e.g., communication circuit 301). In some examples, the stabilization system 410 may be communicably coupled to towing vehicle 404 via the communication circuit, such as through V2X communications, V2V communications, and/or a wired I/O interface (e.g., wiring harness 412). Additionally, the stabilization system 410 may be communicably coupled to an external environment infrastructure 418 using V2X communications over network 420 (e.g., network 390 of FIG. 3). In some examples, towed vehicle 402 may be an over-actuated vehicle as described in connection with FIG. 2.

Towing vehicle 404 may also be implemented as vehicle 100 of FIG. 1 and/or 200 of FIG. 2. Towing vehicle 404 may include also a stabilization system 422, which may be substantially similar to stabilization system 300 of FIG. 3. Accordingly, the stabilization system 422 may be communicably coupled to sensors 424 (e.g., sensors 352 of FIG. 3) via a communication circuit (e.g., communication circuit 301). Sensors 424 may comprise, among other sensors, environmental sensors, wheel angle sensors, and wheel torque sensors. In some examples, the stabilization system 422 may be communicably coupled to towed vehicle 402 via the communication circuit, such as through V2X communications, V2V communications, and/or a wired I/O interface (e.g., wiring harness 412). Sensor data obtained by sensors 424 can therefore be communicated to stabilization system 410 by way of the communication circuit of towing vehicle 404.

External environment infrastructure 418 may comprises edge devices and/or network cloud servers that can provide information of characteristics and conditions from within the environment in which the towed vehicle 402 is traveling. External environment infrastructure 418 may comprise roadside equipment that can detect external conditions, such as weather and wind conditions, within the environment in which the towed vehicle 402 is traveling. In some examples, external environment infrastructure 418 may be configured to obtain weather forecasts that can predict crosswinds conditions. In either case, the information obtained by external environment infrastructure 418 can be provided to stabilization system 410 as sensor data 426.

Hitch 408 may also comprise one or more sensors 428, which can communicably coupled to stabilization system 410 via wiring harness 412 and/or the communication circuit of stabilization system 410. In this example, sensors 428 may be configured to measure an angle, along a plane parallel to the road surface R, between a coupler 440 attached to towed vehicle 402 and a coupler 442 attached to the towing vehicle 404 and having an origin at the ball mount 438. The angle formed between couplers 440 and 442 may be representative of vehicle dynamics, such as a lateral position of the towed vehicle 402 relative to the towing vehicle 404 and the direction of travel 406. Sensors 428, in examples, may include angle sensors or the like. Sensor data obtained by sensors 428 can be communicated to stabilization system 410.

In examples, stabilization system 410 receives sensor data 426 from one or more sources, such as, for example, one or more of sensors 414, 424, 428, and external environment infrastructure 418. A stabilization circuit 434 (e.g., stabilization circuit 310) is configured to analyze the sensor data 426 and generate a stability signature that characterizes external conditions experienced by the towed vehicle 402 and that impacts stability of the towed vehicle/towing vehicle pair. Stabilization systems 410 can compare the stability signature to a stability threshold, stored in memory, to determine if the stability signature corresponds to a potential instability condition. If the stability signature is equal to or exceeds the stability threshold, the stability signature may be considered indicative of an onset of a instability condition.

In examples, the stability threshold be a steady state steady state threshold force that represents a maximum lateral force at which the towed vehicle/towing vehicle pair remains in steady state. The steady state threshold force may be computed from a moment of inertia of the towed vehicle/towing vehicle pair (e.g., based on a velocity and a mass of the pair of vehicles). As such, the stability threshold may be dynamic based on the vehicle dynamics, such as velocity.

In a case that the stability signature satisfies (e.g., is equal to or exceeds) the stability threshold, the stabilization circuit 434 generates one or more control signals 430 that are provided to vehicle system 416 to counteract or otherwise mitigate the instability condition. The one or more control signals 430 may be generated so to cause the vehicle systems 416 to autonomously control at least part of the towed vehicle 402 in a manner selected to mitigate the instability condition.

Sensor data 426 may comprises information concerning vehicle dynamics of the towed vehicle 402 and/or environmental conditions from within the environment in which the towed vehicle 402 is traveling. For example, the sensor data 426 may include information indicating that wheels 432 are lifted off of the road surface R, for example, using pressure sensors and/or a sensor that detects that vehicle 402 is hitched to towing vehicle 404 on the underside of the vehicle 402. In some examples, sensor data 426 may include information indicating the presence of or prediction of (e.g., forecasts) external conditions. In various examples, sensors data 426 includes information indicating the current crosswinds or forecasts of crosswinds, including wind direction and/or wind speed. In some examples, sensor data 426 may include information indicating tire and/or vehicle dynamics, such as orientation of the wheels 432 with respect to direction of travel 406, wheel speed (e.g., angular velocity), lateral position of the towed vehicle 402 relative to towing vehicle 404 and direction of travel 406, and angle between couplers 440 and 442.

Stabilization circuit 434 may analyze the sensor data 426 to characterize an external condition that may have resulted in the sensor data 426. For example, stabilization circuit 434 may obtain sensor data 426 and compute an lateral force (e.g., lateral or generally perpendicular to the direction of travel 406) from the sensor data 426. The computed lateral force may be used to generate a stability signature that characters external conditions, which could have caused the lateral force.

In an illustrative example, sensor data 426 may comprise information indicating the presence of or forecasting crosswinds or pressure fronts. The sensor data 426 may include wind speeds and wind directions, which can be used to compute a lateral force applied to the towed vehicle 402 characterizing the indicated crosswinds. The stability signature may be generated as this lateral force. The stabilization circuit 434 can then compare the stability signature with the stability threshold. If the stability signature is equal to or exceeds the stability threshold, stabilization circuit 434 may recognize the stability signature as indicative of an onset (e.g., potential) of an instability condition. Thus, stabilization circuit 434 may be able to detect the onset of such conditions from current external conditions reflected in sensor data 426 and/or predict future conditions from forces of external conditions reflected in sensor data 426.

In another example, stabilization system 410 may monitor vehicle dynamics of the towed vehicle/towing vehicle pair based on sensor data 426. In this case, stabilization circuit 434 may obtain sensor data 426 containing vehicle dynamics of towed vehicle 402 and/or towing vehicle 404. The stabilization circuit 434 may derive current real-world vehicle dynamics from the sensor data 426, which can be compared to expected vehicle dynamics to determine a difference or deviation therebetween. This difference can be indicative of external conditions experienced by the towed vehicle 402 that has induced the deviation from the expected dynamics. Thus, stabilization circuit 434 may be able to compute a lateral force that was applied to the towed vehicle 402 causing the difference, which can be used to generate the stabilization signature characterizing these external conditions. As described above, the stabilization circuit 434 can then compare the stability signature with the stability threshold to detect an onset of an instability condition.

In an illustrative example, sensor data 426 may include wheel dynamics, such as an orientation of the one or more wheels 432 relative to the direction of travel 406. In this case, sensor data 426 may be obtained from wheel angle sensors and/or wheel torque sensors. The stabilization circuit 434 may compare the detected orientation to an expected orientation to determine an offset. This offset may be indicative of an external condition, such as crosswinds, a pressure front, or the like, applied to the one or more wheels 432 that caused the deviation from the expected orientation. This offset can be translated into a lateral force characterizing the external conditions and used to generate the stability signature.

In another illustrative example, sensor data 426 may include a lateral position of the towed vehicle 402 relative to towing vehicle 403 and with respect to the direction of travel 406. The lateral position can be compared to an expected lateral position to determine an offset therebetween. As in the preceding example, the offset may be indicative of an external condition that caused the towed vehicle 402 to deviate from the expected lateral position and this offset can be translated into a lateral force used to generate the stability signature.

In examples, responsive to the stability signature satisfying the stability threshold, the stabilization system 410 may generate one or more control signals 430 that can cause one or more system 416 to actuate one or more of wheels 432 in a way selected to mitigate the instability condition. In an illustrative example, the one or more control signals 430 may cause a steering system (e.g., steering system 378) to operate so to adjust a steering angle of one or more of the wheels 432 in a direction selected to mitigate the instability condition. For example, if the stabilization system 410 determines there is strong lateral force (e.g., due to a crosswind or otherwise) incident on the driver side front of the towed vehicle 402, the stabilization system 410 may cause the steering system to steer the one or more wheels 432 toward the lateral force (e.g., in a direction toward parallel with the lateral force) to minimize the effect of the lateral force on the one or more wheels 432 (e.g., to minimize a lateral force due to the cross wind) and increase aerodynamics. As another example, the stabilization system 410 may determine to increase a lateral force applied to the one or more wheels 432, and ultimately to the towed vehicle 402, by steering the one or more lifted wheels away the lateral force to prevent jackknifing.

In some examples, stabilization system 410 may decide whether to minimize or maximize the effect lateral force applied to the one or more wheels 432 based on a comparison between the direction of the lateral force and a bending direction of a bend in the hitch 408. For example, due to an unopposed lateral force, hitch 408 may bend forming an angle between coupler 442 and coupler 440 having an origin at the ball mount 438. The direction of the bend (referred to as the bending direction) may be a lateral direction extending from an end of coupler 440 to the ball mount 438. The stabilization system 410 may compare the bending direction to the direction of the lateral force causing the instability condition. If the bending direction is in the same direction as the lateral force of the instability condition, the stabilization system 410 may be configured to maximize the impact of the lateral force by steering the one or more wheels 432 in a direction away the lateral force causing the instability condition. Whereas, if the bending direction is in the opposite direction as the lateral force causing the instability condition, the stabilization system 410 may be configured to minimize the impact of the lateral force by steering the one or more wheels 432 in a direction toward the lateral force.

In some examples, the one or more control signals 430 may be provided to an autonomous or semi-autonomous driving systems (e.g., autonomous or semi-autonomous driving systems 380). In this case, the autonomous or semi-autonomous driving system may execute the one or more control signal 430 by autonomously operating the steering system to actuate the one or more wheels 432, as described above.

In another example, stabilization circuit 434 may generate one or more control signals 430 that causes a torque splitter system (e.g., torque splitters 374) to rotate the one or more wheels 432 at an angular velocity, thereby creating a gyroscopic effect. As a result of the gyroscopic effect, the one or more wheels 432 can mitigate movement of the one or more wheels 432, as well as the lifted portion of the towed vehicle 402, from oscillating relative to the towing vehicle 404 due to lateral forces. The angular velocity at which the one or more wheels 432 are rotated can be based on an angular momentum needed to induce the gyroscopic effect, which may be based on a radius of the one or more wheels 432 and a mass thereof.

In some examples, stabilization circuit 434 may cause the one or more wheels 432 to rotated responsive to detecting that the one or more wheels 432 are lifted from the ground (e.g., towed vehicle 402 is being towed). That is, in some examples, the stability signature may comprise information indicating that one or more wheels 432 are lifted and, in this case, the stability threshold may an indication that the one or more wheels 432 are lifted. Thus, when the one or more wheels are lifted, stabilization circuit 434 may cause the one or more wheels to continuously rotate to generate the gyroscopic effect.

In another example, stabilization circuit 434 may cause the one or more wheels 432 to rotated responsive to predicting that an instability condition will occur. In this case, for example, stabilization circuit 434 may receive information forecasting a lateral force that may be applied to the towed vehicle and the forecasted lateral force may satisfy the stability threshold. In this case, responsive to the predict instability condition, the stabilization circuit 434 may preemptively actuate the one or more wheels 432 by rotating the wheels 432, thereby preemptively generating the gyroscopic effect.

As noted above, towed vehicle 402 may be an over-actuated vehicle. In this case, each wheel 432 that is lifted above the road surface R may be independently operated to provide improved instability mitigation and reduced power consumption. For example, one wheel may be actuated, which consumes power, while the other remains stationary and does not consume power. Further, lateral forces applied to one side of the towed vehicle 402 (e.g., driver side) may be mitigated using the wheel 432 on the driver side, and the passenger side wheel 432 may have minimal effect on mitigating the lateral forces since they are blocked from the vehicle body.

While the foregoing examples are described with reference to stabilization system 410, the present disclosure is not intended to be limited to these examples. In other examples, one or more of the operations described above as performed by stabilization system 410 may be performed by stabilization system 422 of the towing vehicle 404. For example, stabilization system 422 may obtain sensor data 426 and analyze the sensor data 426 to generate the stability signature in a manner substantially similar to the examples described above. Stabilization systems 434 may compare the stability signature to a stability threshold to determine if the stability signature corresponds to a potential instability condition. If the stability signature is equal to or exceeds the stability threshold, the stabilization circuit 434 may generate the one or more control signals 430 to mitigate the instability condition. The control signals 430 may then be transmitted to stabilization system 410 for providing to vehicle systems 416 for execution. In another example, stabilization system 422 may transmit the stabilization signature to stabilization system 410, which can use this to generate control signals 430. As another example, stabilization system 422 may transmit an indication that the stability signature satisfies the stability threshold, which stabilization system 410 can use to generate control signals 430.

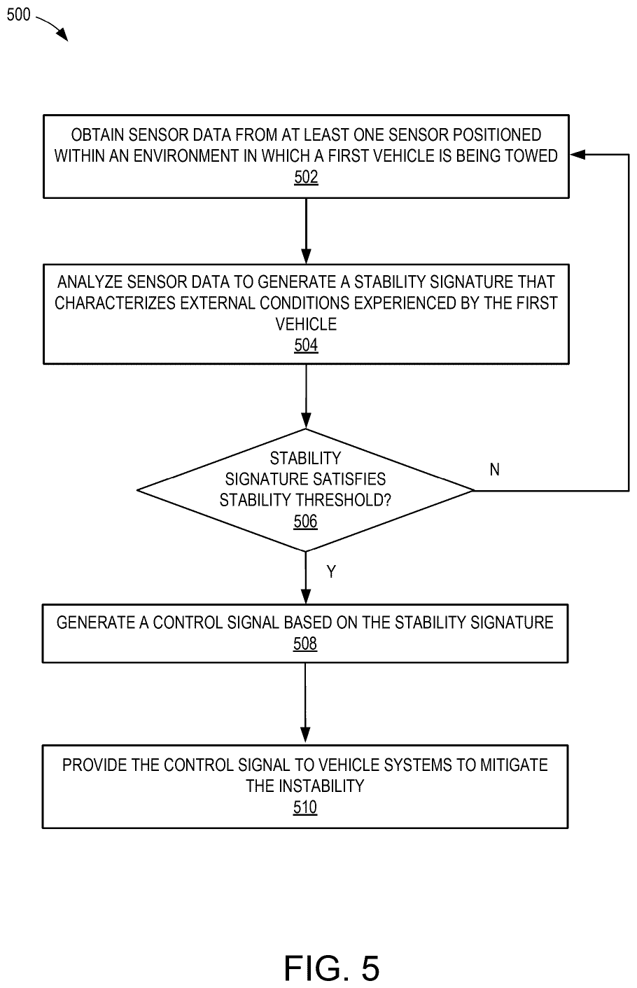

FIG. 5 is a flow chart illustrating example operations for mitigating instability of a towed vehicle in accordance with various embodiments disclosed herein. FIG. 5 provides a process 500 that may be implemented as instructions, for example, stored on stabilization circuit 310, that when executed by one or more processors perform one or more operations of process 500. In another example, process 500 may be implemented as instructions stored on stabilization system 410 and/or 422, that when executed by one or more processors to perform one or more operations of process 500.

At operation 502, sensor data is obtained from at least one sensor positioned within an environment in which a first vehicle is being towed. For example, the first vehicle (e.g., a towed vehicle, such as towed vehicle 402) may be towed by a second vehicle (e.g., a towing vehicle, such as towing vehicle 404) within an environment (e.g., environment 404). Sensor data (e.g., sensor data 406) may be obtained from sensors provided on one or more of: the first vehicle, the second vehicle, and external infrastructure of the environment (e.g., external environment infrastructure 418). As described above, the sensor data obtained at operation 502 may comprise environmental data, such as but not limited to wind speed and wind direction, and/or vehicle dynamics, such as but not limited to wheel orientation and lateral position of the first vehicle.

At operation 504, the sensor data is analyzed to generate a stability signature that characterizes external conditions experienced by the first vehicle while the first vehicle is towed by the second vehicle. For example, as described above in greater detail in connection with FIG. 4, the sensor data may be analyzed to determine a lateral force applied to the first vehicle due to external conditions (such as crosswinds). The lateral force can be used to generate the stability signature.

In examples, operation 504 may comprises analyzing the sensor data to determine current vehicle dynamics and comparing the current vehicle dynamics to expectations to determine deviation from the expectation. In an example, the sensor data can be analyzed to determine a current orientation of the wheel and comparing the current orientation of the wheel to an expected orientation of the wheel to detect an offset therebetween. In another example, the sensor data can be analyzed to determine current lateral position of the first vehicle and comparing the current lateral position of the vehicle to an expected lateral position of the vehicle to detect an offset therebetween. The deviations or offsets can be used to generate the stability signature as described above.

At operation 506, a determination is as to whether or not the stability signature satisfies a stability threshold. For example, as described in greater detail above in connection with FIG. 4, operation 506 may compare the stability signature to the stability threshold to determine if the stability signature is equal to or exceeds the stability threshold.

If the stability signature satisfies the stability threshold, thereby indicating an onset of an instability of the first vehicle, a control signal is generated based on the stability signature at operation 508. The control signal may be generated to operate one or more vehicle systems to actuate a wheel of the first vehicle to mitigate the instability of the first vehicle, as described above in connection with FIG. 4.

At operation 510, the control signal is provided to one or more vehicle systems to mitigate the instability indicated by the affirmative determination at operation 506. For example, the control signal can be communicated to a torque system to cause a wheel of the first vehicle to rotate at an angular velocity selected to induce a gyroscopic effect. In some examples, the wheel may be rotated continuously upon detecting that the wheel has been lifted off the ground (e.g., as indicated in the stability signature). In another example, the wheel may be rotated upon determined that a stability signature that characterizes a forecasted external condition exceeds or is equal to the stability threshold.

In an example, process 500 may be used to mitigating a jack-knife instability condition. In this example, the stability threshold may be defined as a threshold angle (also referred to as a critical angle) that is indicative an onset of a jack-knife instability condition. While the critical angle may be dependent on multiple factors, such as but not limited to, the mass of towing vehicle, the mass of the towed vehicle, weight distribution, tire properties, road conditions, etc., in some examples threshold angle may be between 45 to 60 degrees. A current bending angle may be detected using sensors (e.g., a hitch sensor) (operation 502). The current bending angle may be used to provide a stability signature (operation 504) and compared to the threshold angle (operation 506). If the stability signature satisfies the threshold, thereby indicating an onset of a jack-knife instability, a control signal is generated (operation 508) and provided to one or more vehicle systems to mitigate the instability (operation 510).

In another illustrative example, an onset of a sway instability condition may also be recognized (e.g., detected) based on a bending angle of the hitch. In this example, the threshold angle may be set to plus/minus 20 degrees, as an example. However, other threshold angles may be used based on factors, such as but not limited to, the mass of towing vehicle, the mass of the towed vehicle, weight distribution, tire properties, road conditions, etc. As another example, the stability threshold for a sway instability threshold may be based on an oscillation in bending angle oscillates (e.g., oscillating outside of +/−4 degrees from steady-state). Increasing the value of this angle above this threshold may increase the stringency for recognizing a instability condition at the expense of increased difficulty to recover to stable-state conditions. Other thresholds can be used to recognize the onset of a sway instability condition, such as a ratio of the yaw rate of the towing vehicle with the yaw rate the towed vehicle, ratio of the lateral acceleration of the towing vehicle with the lateral acceleration of the towed vehicle.

As another example, the control signal can be communicated to a steering system to cause the wheel of the first vehicle change a steering angle in a direction determined to mitigate the instability. For example, the stability signature characterizes the external conditions as inducing a strong lateral force, the control signal may cause the steering system to steer the wheel toward the lateral force to minimize the effect of the lateral force and increase aerodynamics. In another example, the control signal may operate to increase a lateral force by steering the wheel away from the lateral force, for example, to prevent jackknifing.

As described above, the first vehicle may be an over-actuated vehicle. Accordingly, process 500 may function to control each wheel of the vehicle individually based on the stability signature. For example, a driver side lifted wheel may be actuated at operation 510 due to an unopposed lateral force on the driver side, while the passenger side lifted wheel is not controlled. In another example, one wheel may be steered in a direction to mitigate instability, while another (or both) are rotated to induce the gyroscopic effect. Examples herein are not limited to these examples, which are provided for illustrative purposed. Other configurations and combinations may be provided as recognizable to one skilled in the art.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

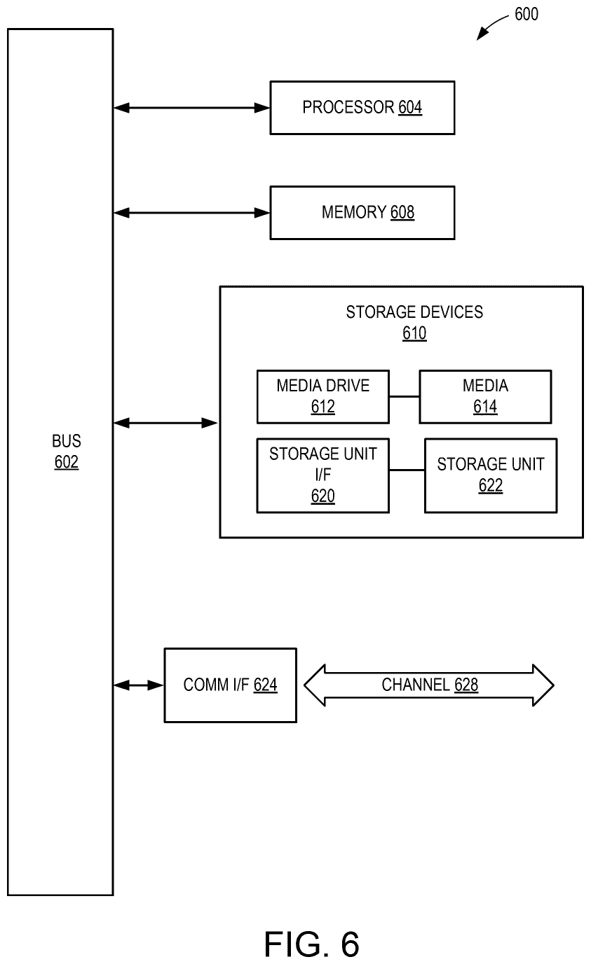

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up stabilization system 300 of FIG. 3 and/or stabilization systems 410 and/or 422 and/or external environment infrastructure 418 of FIG. 4. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 may store instructions that, when executed by processor 604, cause processor 604 to perform the various functions described in connection with FIGS. 1-4, as well as operation of process 500. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
analyzing sensor data from at least one sensor positioned within an environment in which a first vehicle is traveling to generate a stability signature that characterizes external conditions experienced by the first vehicle while the first vehicle is towed by a second vehicle; and
in response to determining the stability signature satisfies a stability threshold indicating an onset of an instability of the first vehicle, generating a control signal based on the stability signature that actuates a wheel of the first vehicle to mitigate the instability of the first vehicle.

2. The method of claim 1, wherein the first vehicle is hitched to the second vehicle on an underside of the first vehicle that causes the wheel to be lifted above a road surface.

3. The method of claim 1, wherein the first vehicle is an over-actuated vehicle.

4. The method of claim 1, wherein the sensor data comprises one or more of: environmental data and vehicle dynamics of the first vehicle.

5. The method of claim 1, wherein the sensor data comprises a wind speed and a wind direction.

6. The method of claim 1, wherein analyzing the sensor data from the at least one sensor to generate the stability signature comprises at least one of:
analyzing the sensor data to determine a current orientation of the wheel and comparing the current orientation of the wheel to an expected orientation of the wheel to detect an offset therebetween; and
analyzing the sensor data to determine a current vehicle dynamic of the first vehicle and comparing the current vehicle dynamic of the first vehicle to an expected vehicle dynamic of the first vehicle to detect an offset therebetween,
wherein the stability signature is based on the detected offset.

7. The method of claim 1, wherein the control signal that actuates the wheel of the first vehicle to mitigate the instability in the first vehicle comprises a signal causing one or more of:
the wheel to rotate at an angular velocity; and
the wheel to adjust a steering angle in a direction determined to mitigate the instability in the first vehicle.

8. The method of claim 1, further comprising:
providing the control signal to an autonomous or semi-autonomous driving system that autonomously actuates the wheel of the first vehicle to mitigate the instability.

9. The method of claim 1, further comprising:
obtaining the sensor data from the at least one sensor, wherein the at least one sensor comprises one or more of: a sensor disposed on the first vehicle; a sensor disposed on the second vehicle; and a sensor of an external infrastructure.

10. A vehicle stabilization system, comprising:
a first vehicle having a wheel and a vehicle system configured to control the wheel;
a memory storing instructions; and
one or more processors communicably coupled to the memory and configured to execute the instructions to:
analyze sensor data from at least one sensor positioned within an environment in which the first vehicle is traveling to generate a stability signature that characterizes external conditions experienced by the first vehicle while the first vehicle is towed by a second vehicle; and
in response to determining the stability signature satisfies a stability threshold indicating an onset of an instability of the first vehicle:
generate a control signal based on the stability signature; and
provide the control signal to the vehicle system to actuate the wheel of to mitigate the instability of the first vehicle.

11. The vehicle stabilization system of claim 10, wherein the first vehicle is an over-actuated vehicle.

12. The vehicle stabilization system of claim 10, wherein the first vehicle is hitched to the second vehicle on an underside of the first vehicle that causes the wheel to be lifted above a road surface.

13. The vehicle stabilization system of claim 10, wherein the sensor data comprises one or more of: environmental data and vehicle dynamics of the first vehicle.

14. The vehicle stabilization system of claim 10, wherein analyzing the sensor data from the at least one sensor to generate the stability signature comprises at least one of:
analyzing the sensor data to determine a current orientation of the wheel and comparing the current orientation of the wheel to an expected orientation of the wheel to detect an offset therebetween; and
analyzing the sensor data to determine a current vehicle dynamic of the first vehicle and comparing the current vehicle dynamic of the first vehicle to an expected vehicle dynamic of the first vehicle to detect an offset therebetween,
wherein the stability signature is based on the detected offset.

15. The vehicle stabilization system of claim 10, wherein the control signal that actuates the wheel of the first vehicle to mitigate the instability in the first vehicle comprises a signal causing one or more of:
the wheel to rotate at an angular velocity; and
the wheel to adjust a steering angle in a direction determined to mitigate the instability in the first vehicle.

16. The vehicle stabilization system of claim 10, further comprising:
providing the control signal to an autonomous or semi-autonomous driving system that autonomously actuates the wheel of the first vehicle to mitigate the instability.

17. A vehicle comprising:
a wheel that is lifted off a road surface while the vehicle is towed;
a vehicle system configured to control the wheel; and
a stabilization system configured to:
receive a control signal in response to a determination that a stability signature satisfies a stability threshold indicating an onset of an instability of the vehicle; and
operate the vehicle system to autonomously control the wheel according to the control signal to mitigate the instability of the vehicle,
wherein the stability signature is based on sensor data from at least one sensor positioned within an environment in which the vehicle is traveling and characterizes external conditions experienced by the vehicle while the vehicle is towed.

18. The vehicle of claim 17, wherein the vehicle is an over-actuated vehicle.

19. The vehicle of claim 17, wherein the stabilization system is further configured to:
obtain the sensor data from the at least one sensor, wherein the at least one sensor comprises one or more of: a sensor disposed on the vehicle; a sensor disposed on a second vehicle; and a sensor of an external infrastructure;
analyze the sensor data to generate the stability signature;
determine whether the stability signature satisfies the stability threshold indicating the onset of the instability of the first vehicle; and
generate the control signal based on the stability signature.

20. The vehicle of claim 17, wherein the stabilization system is further configured receive one of the control signal and the stability signature from the second vehicle.
